(19) United States
(12) Patent Application Publication
(10) Pub. No.: US 2025/0028168 A1
(43) Pub. Date: Jan. 23, 2025

(54) Smooth Metal Electrowetting Lens Cavity and Lens System

(71) Applicant: Regents of the Univ of Colorado, a body corporate, Denver, CO (US)

(72) Inventors: Ryan Oroke, Boulder, CO (US); Eduardo Miscles, Albuquerque, NM (US); Samuel Gilinsky, Superior, CO (US); Mo Zohrabi, Longmont, CO (US); Juliet Gopinath, Boulder, CO (US); Victor Bright, Boulder, CO (US)

(73) Assignee: Regents of the Univ of Colorado,, Denver, CO (US)

(21) Appl. No.: 18/780,109

(22) Filed: Jul. 22, 2024

Related U.S. Application Data
(60) Provisional application No. 63/514,873, filed on Jul. 21, 2023.
(60) Provisional application No. 63/583,494, filed on Sep. 18, 2023.
(60) Provisional application No. 63/673,690, filed on Jul. 20, 2024.

(51) Int. Cl. G02B 26/00; G02B 26/02

(52) U.S. Cl. CPC G02B 26/005; G02B 26/02

(57) ABSTRACT

An electrowetting lens cavity for use in an electrowetting lens is formed of a metal such as aluminum, having an inner surface tapering downward to an aperture, and smooth enough to allow lensing. The inner surface may be machined and then polished to a roughness of under 0.1 μm. The cavity may form a truncated cone, with the aperture diameter significantly smaller than the tapering part of the inner surface. Dielectric and hydrophobic layers may be formed on the surface of the cavity.

U.S. Pat. No. 11,493,749, issued 8 Nov. 2022, is incorporated herein by refences. Provisional applications for patent 63/514,873 (filed 21 Jul. 2023), 63/583,494 (filed 18 Sep. 2023) and 63/673,690 (filed 20 Jul. 2024) are incorporated herein by reference.

This invention was made with government support under National Institutes of Health grant number 1UF1NS116241, National Science Foundation grant number 1919148, and Office of Naval Research grant number N00014-20-1-2087. The government has certain rights in the invention.

### BACKGROUND OF THE INVENTION

### Field of the Invention

The present invention relates to tunable electrowetting lenses.

### Discussion of Related Art

The electrowetting-on-dielectric (EWOD) effect enables interfacial surface tension control between a polar liquid droplet and an electrically isolated solid substrate using an applied voltage. Tunable lens action can be achieved by modulating droplet contact angle and thus, the radius of curvature of the liquid. Lensing can be achieved with a single liquid and air, or a combination of density matched polar and non-polar liquids.

Given the compact nature and focal tunability of EWOD optical devices, it is no surprise that they have been incorporated in a wide variety of applications, including beam steering, microlens arrays, 3D scanning, and microscopy.

### SUMMARY OF THE INVENTION

A tunable electrowetting lens streamlines the fabrication of tunable optics by integrating an electrowetting lens cavity comprising a metal such as aluminum. The cavity inner surface tapers downward to form an aperture at its lower end. Sloped cavity walls sloped cavity walls can bias the initial curvature of the droplet towards greater convergence or divergence. The initial shift in curvature can be selected to produce focal length tuning for a desired operating range.

For example, the sloping portion of the inner surface might form a truncated cone. After machining, the inner surface is polished sufficiently to allow electrowetting lensing. For example, the surface roughness might be reduced from 0.56 μm to 0.1 μm or less, e.g. between 0.02 μm-0.1 μm. The cone walls have, for example, a 45° slant. In general the slant is determined according to the combination of liquids used, and is chosen to allow the tuning range of the lens to be approximately centered such that it can be tuned a sufficient amount in the converging and diverging direction. In general, the wall slant will be between around 30°-60°.

An example electrowetting lens is an aluminum cavity which eliminates the need for electrode deposition. Production of the cavity used standard subtractive machining which provided the flexibility to customize focal length tuning range using wall slope. Control over the lensing cavity's geometry resulted in a tunable lens with a significantly larger tuning range (demonstrated to be [−54, +88] m-1) than commercially available alternatives [−35, +35 m-1]. The lens includes a fully replaceable package, enabling imaging beyond the laboratory environment. Packaging flexibility also enables the potential reuse of the same lens body with different liquid combinations, allowing optimization for different wavelength coverage, response speed, and tuning range.

In one example, the aluminum is polished using standard shop processes. It is characterized to a tunability of −134 mm to −18.5 mm when diverging, +11.3 mm to +134 mm when converging, and with an input-shaped response time of 149 ms. The tunable lens is contained within a sealed housing, enabling more robust use of the tunable optic beyond a laboratory environment. In one embodiment, the aluminum cavity substrate is sealed inside a 3D printed housing using three O-rings, two optical windows, and two removable threaded plugs.

Smooth metal electrowetting lens cavities have the potential for high tunability. As an example, an EWOD lens leverages an Aluminum 6061-T6 machined cavity to produce a lens capable of operation in both diverging and converging regimes. As a feature, the demonstrated lens package may be sealed with O-rings rather than permanent adhesives, allowing the device to be reliably disassembled and reassembled. It is sized and shaped to fit a standard one-inch optical mount. The device is symmetrical as well.

Metal cavities have several advantages. They can act as one of the electrodes of the EWOD lens. They are tough and maintain their shape over long periods of use. They can be made smooth enough to allow the electrowetting effect to work, and can be accurately shaped to achieve desired tunability. For example, a conical inner surface with a long-sloped wall has been found to work well.

In an example, a lens design includes a conical cavity machined to standard shop tolerances (+0.127 mm) from Aluminum 6061-T6. A 45° cavity wall slope was selected to increase positive focal length tunability as compared with a cylindrical EWOD lens. To reduce the roughness of the electrowetting surface below the drawing specified 0.4 μm average roughness (Ra), a mechanical polishing method was performed with a jeweler's drill press, diamond paste, and felt polishing bob. This process reduced roughness from 0.56 μm to below 0.1 μm Ra, in this case to 0.038 μm. As an alternative, a different machining process may achieve greater smoothness. In some cases, machining is precise enough that an additional polishing step is not required.

The cavity inner surface is coated with a dielectric layer and a hydrophobic layer. An embodiment configures the conical cavity substrate with 3 μm of Parylene HT as a dielectric layer and dip-coated in roughly 0.6 μm of Cytop as a hydrophobic layer. Though several liquid combinations would be compatible with the demonstrated lens, deionized water (DI) and 1-phenyl-1-cyclohexene (PCH) were selected in one case for the combination's large refractive index contrast (Δn=0.24), density matching (Δp=0.004 g/mL), and immiscibility. Further, the large water-to-substrate contact angle of unactuated DI and PCH on Cytop (173°) enabled lens tunability to a greater diverging power.

An example lens package has various advantages:
The lens has an aperture diameter much smaller than the length of its sloped cavity walls, enabling a much larger tunability range. This allows strong lensing when diverging or converging.
The optic is packaged using three flouroelastomer O-rings such that it can be completely disassembled and reassembled without damage to components. The housing does not use any permanent adhesives or sealing methods.
The lens uses a liquid combination of deionized water and 1-phenyl-1-cyclohexene. These liquids are closely density matched, low viscosity, highly transmissive in the visible spectrum, and immiscible.
The lens has a dielectric layer of Parylene HT.
One electrical connection is made with a set screw that mashes into the aluminum substrate, while the other attaches to a pear-shaped optical ground plane.
Wiring to the lens is mechanically strain relieved by the housing itself. This is done by weaving the ground and V+wires through the struts of the package.
The lens directly interfaces with standard optical hardware.
The lens is robust enough for external use.
The lens directly interfaces with standard optical hardware, including optical mounts such as 1″ mounts, enabling easier use in larger optical systems.

An electrowetting lens cavity is structured as a metal chamber configured for use within an electrowetting lens. It has an inner surface that is smooth enough to allow electrowetting lensing within the electrowetting lens, and tapers downward to form an aperture, often monotonically converging downward. For example the cavity may form a truncated cone. In one example, the cone slopes at around 45°. Many examples have a slope that falls within between 30° and 60°. The diameter of the aperture is often smaller than the sloping part of the walls, sometimes quite a bit smaller, e.g. half or less. An example has an aperture of 2.5 mm, and many have apertures of 4 mm or less. Often the geometry of the cavity, and especially the wall slope, is chosen to allow both converging and diverging lens behavior for a chosen set of liquids, e.g. deionized water and PCH.

The metal of the cavity may be aluminum (e.g. Aluminum 6061-T6), which has good machining and conductivity properties. Subtractive machining may be used, e.g using a mill or lathe. The inner surface is quite smooth, for example having a roughness of under 0.1 μm or under 0.05 μm. An example has roughness of about 0.038 μm.

The electrowetting lens cavity of claim 1 may have a dielectric layer and a hydrophobic layer formed on the inner surface. An example is Parylene HT and Cytop. One embodiment has a conformal coating of 3.0 μm of Parylene HT and a dip coat of 0.6 μm of 10% wt Cytop.

The electrowetting lens cavity can be sized and shaped to fit within an electrowetting lens housing, which in turn may be sized and shaped to fit a standard one-inch optical mount. It includes a top wind and a bottom window. These may be formed of laser cut fused silica wafer. A potential is formed between the cavity wall and the top of the liquid in the lens. For example, an electrode may be inserted into the wall of the cavity and the ground may be formed on the top window of the cavity, or vice versa. The top side of the circuit may be adjacent to the top window as well. If it is formed on the top window it may include a Ti—Au coat on the window. The sidwall electrode may include a set screw which may be screwed into a fitting of threaded brass or the like which is sunk into the wall.

The circuitry between the electrode and the electrode ground for focusing the electrowetting lens may provide AC potential. In some cases, the circuitry overdrives the lens, for example by 50%, or between 25% and 75%. The overdriving may occur for at least 20 ms, in this case between 0 ms and 100 ms.

In some embodiments, the lens is configured to come apart, for example by not using permanent adhesives. The lens may be held together by clips or screw caps, and sealed with O-rings. The O-rings may be formed of a material that swells under 30% such as an elastomer such as Viton fluoroelastomer. The O-rings in these examples form a seal between the windows and the housing and may also hold the cavity in place within the housing. When a set screw is used in the sidewall electrode, it can also be removed by unscrewing it.

### BRIEF DESCRIPTION OF THE DRAWINGS

FIG. 1A is a top isometric view of an electrowetting lens cavity. FIG. 1B is a side cutaway view of the cavity.

FIG. 2A is a high-level schematic drawing of an electrowetting lens using the cavity. FIG. 2B is a more detailed view of an electrowetting lens using the cavity.

FIG. 3A is an exploded view of the electrowetting lens. FIG. 3B is a view of a portion of an assembled lens.

FIGS. 4A-D are a side cutaway views of a wall of the cavity as fabricated.

FIG. 4E is a plot showing the reduction in surface roughness that produces a sufficiently smooth cavity for electrowetting.

FIGS. 5A-C show the lens in use at various levels of voltage applied.

FIGS. 6A and 6B are plots showing focal length versus voltage as modeled and with experimental results.

FIGS. 7A-D are side schematic views of electrowetting lenses using various alternative shapes of cavity.

FIG. 8 is a side schematic block diagram of an imaging system used to characterize focal length tunability.

FIG. 9 is a side schematic block diagram of a widefield imaging setup.

FIGS. 10A-10C are plots illustrating improved performance with overdriven voltage.

### DETAILED DESCRIPTION OF THE INVENTION

Table 1 shows reference numbers and associated elements.

TABLE 1

| Reference number | Element |
|---|---|
| 100 | Cavity for tunable liquid lens |
| 102 | Outer walls |
| 104 | Inner surface/walls |
| 106 | Aperture |
| 110, 112 | Fillets |
| 200 | Liquid lens |
| 202 | Housing |
| 204 | Deionized water |
| 206 | 1-Phenyl 1-Cyclohexene |
| 208 | Parylene HT layer |
| 210 | Cytop layer |
| 212 | Optical window |
| 214 | Brass insert |
| 216 | Sputtered gold |
| 220 | O-ring |
| 222 | Screw |
| 224 | Clip ring |
| 226 | Electrical driver |
| 228 | Optical window |
| 302 | V+ wire |
| 304 | Strain relief wire |
| 306 | Twisted wires |
| 308 | Housing strut |
| 402 | Inner wall surface |
| 802 | Collimated Laser Diode Source |
| 804 | Mirrors |
| 806 | Lenses |
| 808 | Translating imaging optics |
| 810 | Beam profiler |
| 900 | Widefield system |
| 902 | Imaging plane |
| 904 | Camera lens |
| 906 | CMOS detector |

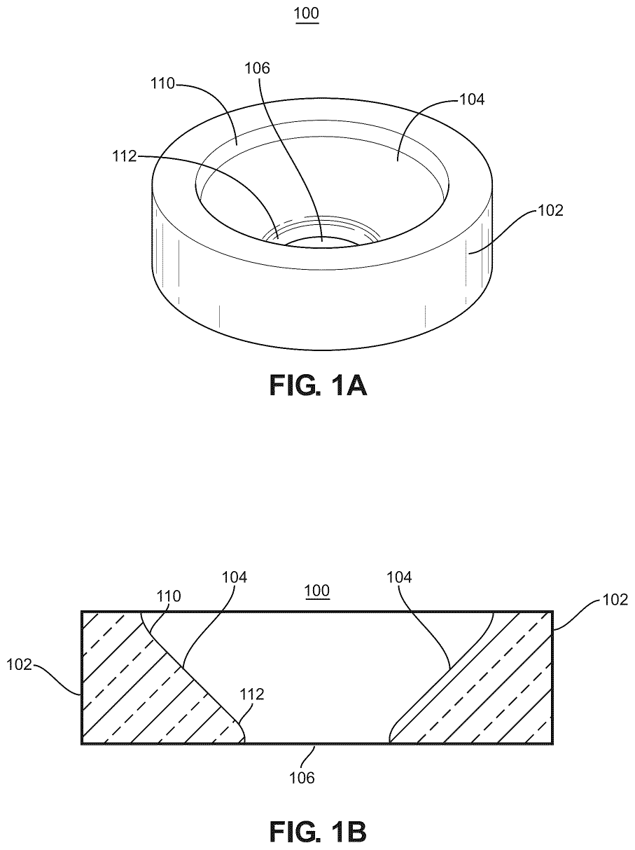

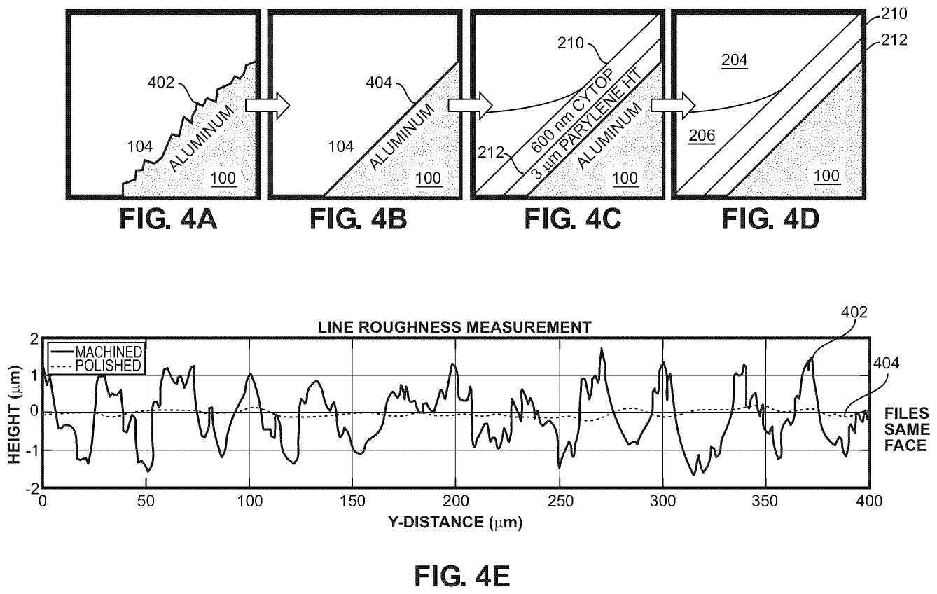

FIG. 1A is a top isometric view of an electrowetting lens cavity 100. FIG. 1B is a side cutaway view of cavity 100. In this example, the slanted portion of inner surface 104 tapers downward at a slope of about a 45° angle relative to vertical (and outer walls 102), which provides more even tunability for DI water contact angles of 60-173°. Aperture 106 is small in diameter compared to the length of the slopes of inner walls 104. In this particular example, fillets 110 and 112 above and below the tapering part of the inner surface cause the top and bottom edges of inner walls 104 to approach vertical but this is optional. In an example, cavity 100 is formed of machined aluminum 6061-T6 to leverage the metal's excellent conductivity, corrosion resistance, and well-understood machining behavior. Surface roughness after machining is reduced as shown in FIGS. 4A-E.

Aperture 106 in this example is 2.5 mm in diameter, which limits gravitational distortion in combination with one specified liquid combination and sloped wall geometry (here. The liquid combination heavily influences maximum aperture size.

An aperture size on the order of up to a few centimeters falls within the field of possibilities for machined electrowetting cavities with proper liquid combination selection.

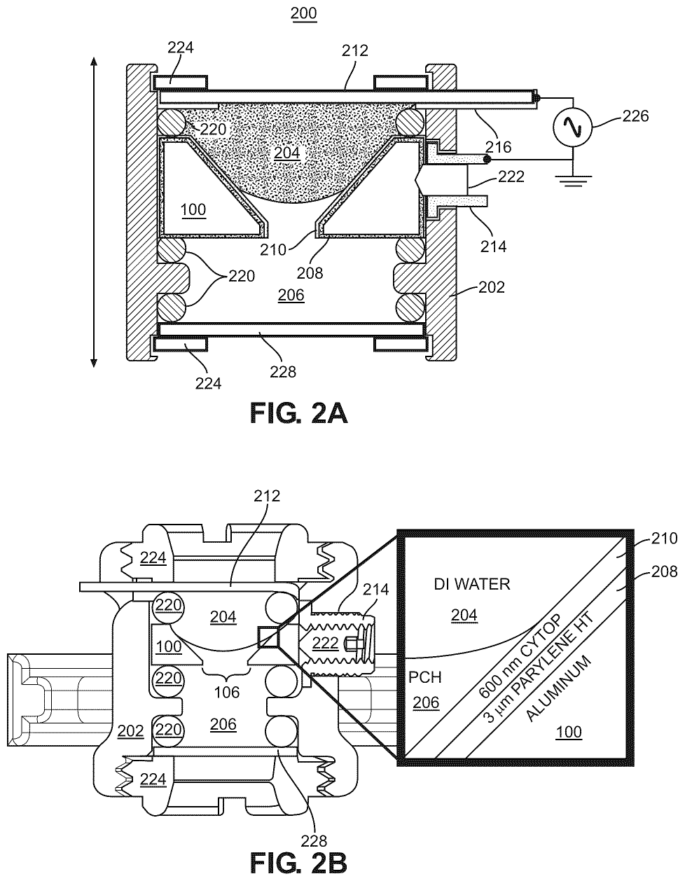

FIG. 2A is a high-level schematic drawing of an electrowetting lens 200 using cavity 100. It comprises 3D printed housing 202 containing deionized water 204 and 1-Phenyl-1-Cyclohexene 206 and is capped by windows 212, 228. Clip rings 218 hold lens 200 together, and O-rings 220 seal and hold the elements in place. Since no permanent adhesive is used, lens 200 can be taken apart and refilled or filled with a different liquid combination or a different cavity 100.

Good lens performance in one example is achieved using a liquid combination of deionized water 204 (DI) and 1-phenyl-1-cyclohexene 206 (PCH). This combination was chosen for its high refractive index contrast (Δn≈0.24), density matching (Δρ≈0.004 g/cm³), and immiscibility.

In this example, electrical driver 226 drives AC current between window 216 and the electrode formed by screw 222 and insert 214, which are connected to ground. In other examples, such as the embodiment of FIG. 2B, these are reversed, with window 216 attached to the ground.

In this embodiment, cavity 100 is coated with a parylene HT layer 208 and a Cytop layer 210, better shown in FIG. 2B. Top window 212 is layered with sputtered gold 216. One electrode is provided by a set screw 222 threaded through brass insert 214 and driven into substrate 100 to create an electrical path. Driver 226 provides voltage between top window 212 gold layer 216 and cavity substrate 100. Varying the voltage changes the focal length of lens 200. Lens action is created when an electrical potential is applied between the DI water 204 and aluminum cavity substrate 100. In other embodiments the electrode may be separate from top window 212.

FIG. 2B is a more detailed view of a cross-section of an actual electrowetting lens 200 using the cavity 100. In an example a 3 μm layer of Parylene HT was used as the lens's dielectric layer, and a 600 nm layer of dip-coated Cytop was used as a hydrophobic layer (see FIGS. 4A-D). A liquid combination of deionized water (DI) and 1-phenyl-1-cyclohexene (PCH) was used as the liquid combination on account of its high refractive index contrast, low density mismatch, and immiscibility.

In this example, housing 202 is sized and shaped to fit within a standard 1-inch optical mount. Clip rings 224 have been replaced with threaded plugs 224. To the right of FIG. 2B is an exploded view of a portion of inner surface 104 of cavity 100 coated with a 3μ Parylene HT layer 208 and a 600 nm Cytop layer 210.

This design has focal tunability of tunability of −134 mm to −18.5 mm when diverging, +11.3 mm to +134 mm when. Its optimized 2% settling time is 149 ms.

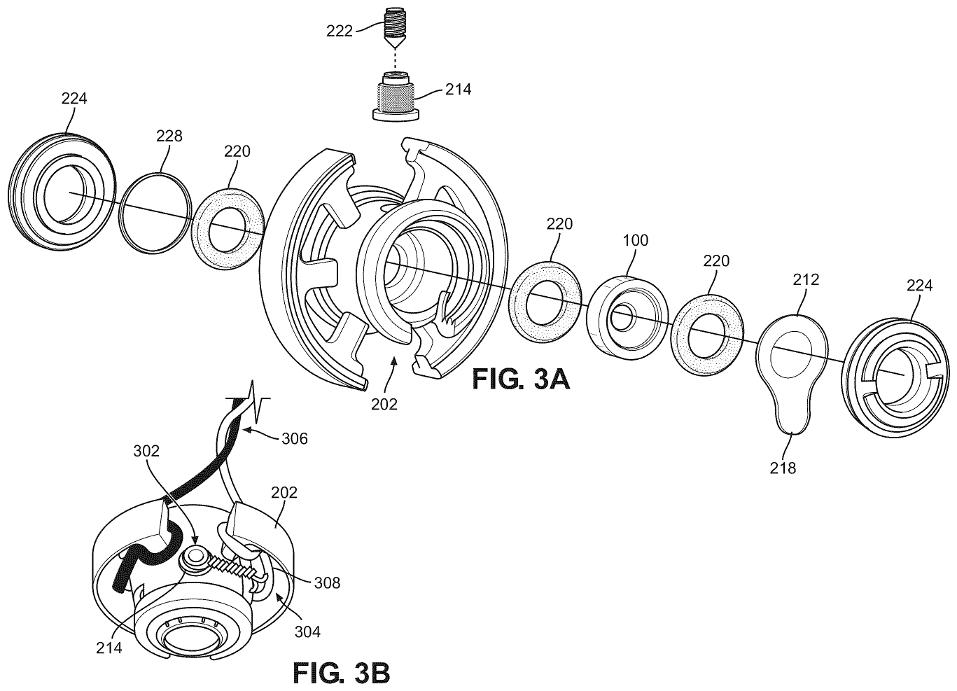

FIG. 3A is an exploded view of electrowetting lens 200. One specific embodiment is described below. Each window 212, 228 is sealed by a fluoroelastomer O-ring 220 and threaded plug 224. Windows 212 are laser cut 500 μm fused silica and contain the package liquids. In an example, top window 212 is the ground for electrode 222. Optical window 212 is masked with Kapton and sputtered in Ti—Au and is connected to electrical driver 226 with silver epoxy.

O-rings 220 are composed of Viton™ flouroelastomer to avoid chemical interaction with PCH. O-rings were chosen to seal the proposed lens package because of their compactness and the ability to assemble a lens without permanent adhesives. Other methods of manufacturing include as laser-cut gasket material.

Housing 202 was printed on Anycubic Photon M3 Premium with ABS-like+ Resin. Resolution was to 28.5 μm spot size, sufficient for printing ⅜-24 threads for caps 224.

The pear shape of window 212 provides an extension used to move the electrical ground connection outside the diameter of the lens packaging. The extension allows the electrical connection to driver 226. To enable optical window 212 to electrically connect with the DI water 204, a layer of titanium (10 nm) and gold (200 nm), referred to as Ti—Au, was sputter coated onto window 212 in a PVD 36 Nano sputter deposition chamber. Before deposition, each window was masked with a 4.75 mm circle of laser-cut Kapton tape to ensure transparency along the lens's optical axis. In an example, a pear-shaped optical ground window 212 was laser cut from a 500 μm fused silica wafer to contain the package liquids. An electrical ground path was added to this window using a DC magnetron sputter deposition system to adhere 10 nm of titanium and 200 nm of gold. During this fabrication step, a Kapton mask was used to prevent deposition within the optical aperture of the window. Silver epoxy connected a wire to the conductive layer to enable external grounding. An uncoated optical window 228 was produced using the same laser-cutting technique for the rear window of the optical package. The brass insert 214 and set screw 222 combination provided the driving electrical signal to the cavity 100. After burrowing the set screw 222 into the aluminum substrate, the extruding portion of the brass insert 214 was electrically connected to provide AC potential to the wetting surface. Use of the set screw 222 provided for non-permanent electrical contact with the substrate and enabled complete package disassembly if so desired. These components were contained within a 3D-printed housing printed using stereolithography (Anycubic Photon M3 Premium).

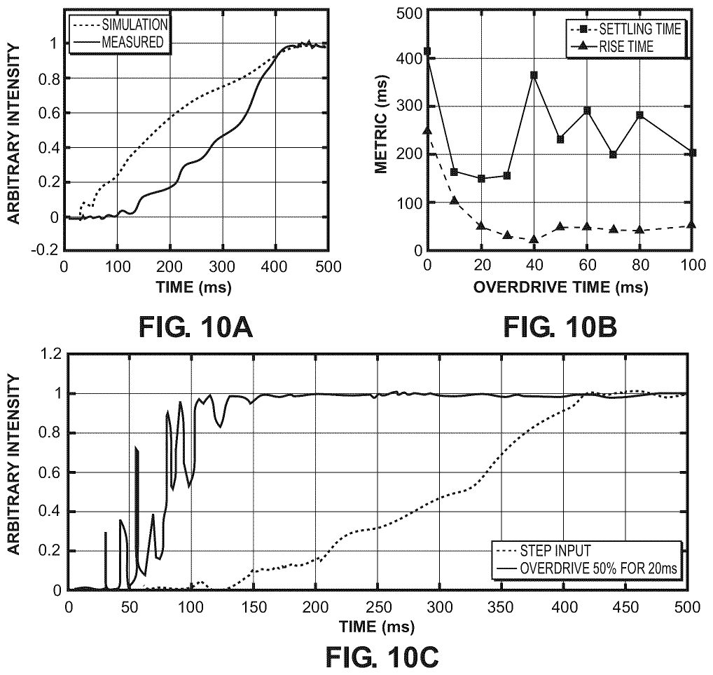

The devices were actuated with an alternating current, which has been shown to improve the performance lifetime of EWOD optics by limiting charge injection into the dielectric. Further shaping of the driving signal's root mean squared (RMS) potential has also improved device performance. Many electrocapillary systems take this a step further and improve response time using a technique known as overdriving. An overdriven waveform is generated when a step-shaped input is modified to initially exceed a desired steady-state potential for a set time span. After this period, the potential overshoot is reduced to the steady state value and the system can settle to rest. This leveraged this overdriving technique to improve lens performance for a 3 kHz square wave input. See FIGS. 10A-10C.

FIG. 3B is an isometric view of a portion of an assembled lens 200. V+wire is wrapped around brass insert 214 to make electrical contact to driver 226. Housing strut 308 provides strain relief to wiring to improve stability. In addition, wires 306 are wrapped together to prevent strain. To enable the tunability of the EWOD lens 200, an electrical connection was provided to both the aluminum substrate 100 and optical window 212. To connect with the optical window's sputtered Ti—Au layer, a 26 AWG black wire was attached using MG Chemicals 8331D-14 silver epoxy. For electrical connection with the aluminum substrate, a set screw 222 was threaded into brass insert 214 and burrowed through the various substrate coatings into the aluminum substrate of cavity 100, creating an oxide-free connection. Since all metals involved in this connection were conductive, a wire 302 was then wound around the exterior of the threaded insert 214 to enable electrical connectivity with an external power supply driver 226, all without compromising the integrity of the package seal. To drive the tunability of this EWOD lens, a National Instruments PCIe-6738 data acquisition (DAQ) card was connected to an Okotech Bipolar HV Amplifier. An AC potential generated by this amplifier was then connected to the leads of the lens to create focal length tunability.

FIGS. 4A-D are side cutaway views of an inner wall 104 of cavity 100 as it is fabricated (not to scale). FIG. 4A shows cavity 100 after is machined. A macro-scale fabrication process was used for creating a millimeter-scale 45° conical cavity. Therefore, standard machining, such as milling and turning, was chosen to fabricate cavity substrate 100. Recognizing the opportunity to eliminate the need for an additional metal electrode deposition procedure, the substrate was machined from a conductive metal. Given its widespread use in engineering applications, Aluminum 6061-T6 was selected as the substrate material in this example. In addition to the electrical conductivity and corrosion resistance of Aluminum 6061, the material's machinability is an advantage. Additionally, the capability to specify a surface roughness callout on the substrate's part drawing would help enable reversible wetting on the material's surface.

Inner wall 104 has a rough surface 402, not sufficient for EWOD. In one example, manufacturing tolerance was +0.005 inches (+0.127 mm) across the entire part. To ensure a higher quality finish on the wetting surface of the component, an additional 16 μin (0.4 μm) average roughness (Ra) tolerance was specified. Measured surface roughness after machining was 22 μin (0.56 μm).

FIG. 4B shows inner wall 104 with a much smoother surface 404. In this example, this was accomplished with hand polishing. A mechanical polishing procedure was performed using a felt bob, 0-2 μm grit diamond paste, and lapping oil. A white light vertical scan profilometer (Veeco Wyko NT3300) measured the reduction in radial roughness from 0.56 μm to 0.038 μm Ra. It is likely that the effectiveness of this procedure arises from its efficiency in removing the material comprising rough profile peaks and sharp corners. In addition to improving electrowetting action, removing peaks reduces the risk of dielectric breakdown caused by a sharp electric field concentration during device actuation.

Polished substrates were O₂ plasma etched to eliminate organic residue and prepare the aluminum surface for dielectric layer deposition. These substrates were sent to a commercial supplier for conformal coating in 3.0 μm of Parylene HT. In particular, Parylene HT was selected for its low relative dielectric constant (εεd=2.20 at 1 KHz), high electrical breakdown (212.6 V/μm), and pinhole-free deposition [66]. Parylene HT was selected explicitly over Parylene C for its better UV resistance and higher processing temperatures. Upon return, cavities were dip-coated in 10% wt Cytop (CTL-809M and CT-Solv 180) and baked (185° C. for 45 minutes) to obtain a 0.6 μm hydrophobic wetting surface. Cytop increased the starting droplet contact angle to 173° for DI-PCH liquid combinations, resulting in large contact angle tuning ranges. Including a hydrophobic layer in EWOD devices also reduced droplet pinning and contact angle hysteresis.

FIG. 4C shows the addition of a 3 μm Paralene HT layer 208 and a 600 nm Cytop layer 210. Dielectric Paralene HT layer 208 has electrical breakdown of 212.6 MV/m and dielectric constant Ed=2.20 at 1 KHz. It has a higher processing temperature (350° C.) than Parylene C (80° C.), and better UV stability. Hydrophobic layer 210, comprising 600 nm Cytop, is formed by dip-coating. It was found to increase CA to 173°.

FIG. 4D shows cavity 100 in use, with deionized water 204 and PCH 206. Refer back to FIGS. 2A and 2B.

FIG. 4E is a plot showing average surface roughness (Ra) 402 (machined) and average surface roughness (Ra) 404 (polished after machining). In one test, surface roughness after machining 402 was 22 μin (0.56 μm), while surface roughness after polishing 404 was reduced to 38 nm.

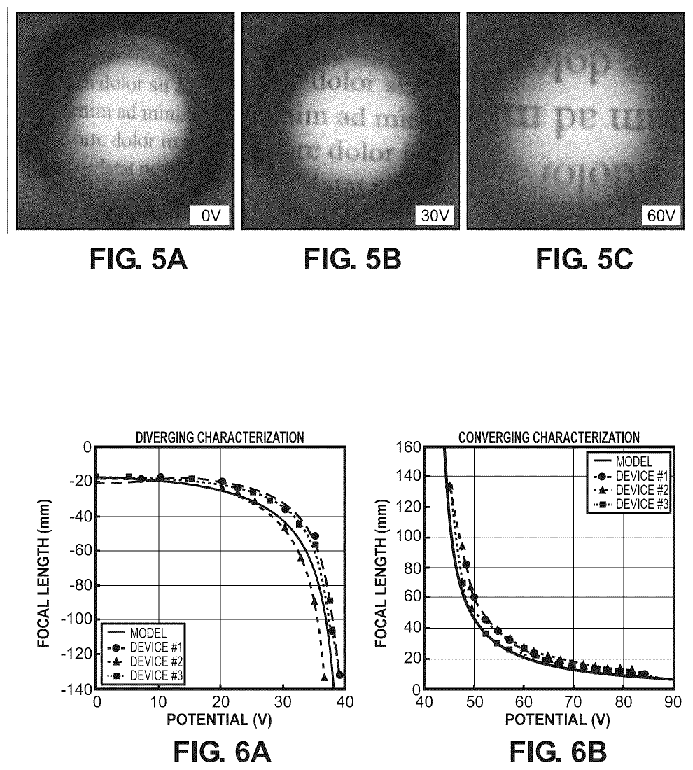

FIGS. 5A-C show the performance of EWOD lens 200 in use at various levels of voltage applied as shown in FIG. 2A. FIG. 5A is the unactuated result at 0V, FIG. 5B is the magnified result at 30V, and FIG. 5C is the result at 60V, further magnified and also inverted, as the lens becomes sufficiently convergent to focus between the tunable device and adjustable camera lens. The images indicate that the lens exhibits no immediate signs of significant optical aberration.

Widefield imaging was performed to evaluate the liquid meniscus qualitatively. Visual targets were imaged through the tunable device and an adjustable camera lens to focus the imaging plane onto a detector. Target magnification was produced by successively increasing the EWOD optic's driving potential and adjusting the variable camera lens to bring the image back into focus. This method produced the images in FIGS. 5A-C. The quality of the text is well preserved as the driving voltage progresses from 0 to 30 V in FIG. 5B, where the lens operates in a diverging regime. The image quality remains unchanged for a converging meniscus at 60 V in FIG. 5C. At this voltage, the lens converges enough to focus between the device and the adjustable camera, producing an inverted image. Inspection of the images indicates that the lensing interface does not contain immediately apparent optical aberrations and would be suitable for many widefield imaging applications. Numerical characterization of the lensing interface in similar devices has further proven the quality of electrowetting-based lenses, demonstrating negligible non-spherical wavefront aberration.

Focal length tuning was also characterized to confirm the custom cavity's balanced focusing behavior. SolidWorks and Zemax Optic Studio were used to predict the back focal length of the package as a function of contact angle. This modeling began by replicating the lensing cavity as a 3D model in SolidWorks, including defining the spherical cap interface of the two liquid volumes. By varying the contact angle of the droplet and performing a SolidWorks Design Study to enforce approximate volume constancy, the geometry of the non-polar liquid droplet was obtained as a function of liquid contact angle in increments of 2.5°. Each of these discrete geometries was passed through an optical model in Zemax OpticStudio to predict the back focal length of the packaged device. Following the conversion of contact angle to driving potential using the Lippman-Young Equation, these individual predictions were plotted and fit to the continuous function:

$$f ( VRMS ) = \frac{a}{{VRMS}^{- b}} + c , a , b , c ∈$$

where f is the back focal length of the optical package, VRMS is the root mean square of the AC driving potential, and a, b, c are fitting parameters. The predictions of this method can be found in FIGS. 6A and 6B.

The focal spot of an actuated device was imaged onto a beam profiler to measure focal length tunability. The divergence or convergence of a 635 nm collimated laser diode source (0.5 mm FWHM diameter) was measured as it passed through the device. Two converging glass lenses and a beam profiler were collocated on a rail behind the EWOD lens. By translating this 4f imager along a rail, the focal spots of the tunable and first fixed lens (Thorlabs 150 mm LA4874-A-ML) were overlapped such that the beam waist on the profiler was minimized. The distance between the collector and tunable package was used to deduce the back focal lens of the adaptive element. The results of this characterization for three separate lens packages can be found in FIGS. 6A and 6B, giving a back focal length tunability of [−134, −18.5 mm] and [+11.3, +134 mm]. These results closely agreed with the model prediction of [−∞, −18.4 mm] and [+8.4 mm, +∞], with an experimental flat meniscus value of 41.3 V versus a model value of 41.1V. The slight disagreement between the observed and modeled focal lengths at higher potentials is assumed to result from the contact angle saturation of the liquid meniscus, the volumetric liquid discrepancy between the simulated and physical device, or distance measurement error at the higher numerical aperture produced by converging lensing.

FIGS. 6A and 6B are plots showing back focal length tunability versus voltage as modeled and with experimental results. FIG. 6A is a converging characterization, and FIG. 6B is a diverging characterization. The experimental results closely track the modelled results. Lens 200 was driven with a 3 kHz square wave. By changing the shape of the driving wave to a square, the risk of dielectric breakdown, a function of peak-to-peak voltage, was reduced by bringing RMS potential and peak-to-peak potential into unity.

The spot size of the 635 nm light source was minimized onto the translating imager such that the focal spot of the EWOD lens and translating imager overlapped.

Notice the close agreement between the predicted result (tuning of −∞ to −18.4 mm when diverging and +8.4 mm to +∞ when converging, flat at 41.1 V) and experimental result (tuning of −∞ to −18.5 mm when diverging and +11.3 mm to +∞ when converging, flat at 41.3 V).

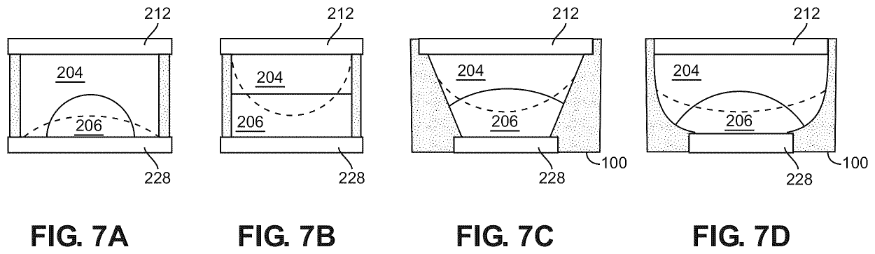

FIGS. 7A-D are side schematic views of electrowetting lenses using various alternative shapes of cavity. Sloped cavity walls can bias the initial curvature of the droplet towards greater convergence or divergence. The initial shift in curvature can be selected to produce focal length tuning for a desired operating range. In each of the four lenses, a polar liquid 206 actuates through a tuning range of 90° to 45° to produce variable focus lensing. Notice the significantly different initial (solid line) and final (dashed line) tuning ranges for the four cavity geometries.

Strikingly different meniscus curvatures occur when different cavity geometries are employed for the same liquid combination. For each cavity, two fluids 204 and 206 are shown without voltage applied (solid lines) and with voltage applied (dotted lines). Even when liquids begin modulation at the same initial liquid-to-substrate contact angle, 90° here, the radius of curvature of the liquid-liquid interface varies dramatically.

For more traditional device designs of FIGS. 7A and 7B, the curvature of the liquid-liquid interface is limited by wall geometry and liquid contact angle, such that minimal flexibility exists in choosing a tuning range. The introduction of a sloped inner surface in FIG. 7C, however, provides the flexibility to select a tuning balanced between converging and diverging lensing behavior. For the DI-PCH liquid combination used in an example lens, the contact angle could be tuned between 173° and 60°. This contact angle modulation range produced a simulated tuning of [−∞, −9.0 mm] and [+17.9, +∞ mm] for a truncated cylindrical cavity device with a 4 mm aperture. Further customization of sidewalls, such as the spherical cavity of FIG. 7D enables even greater control over lens power, though fabrication is likely to be more complicated.

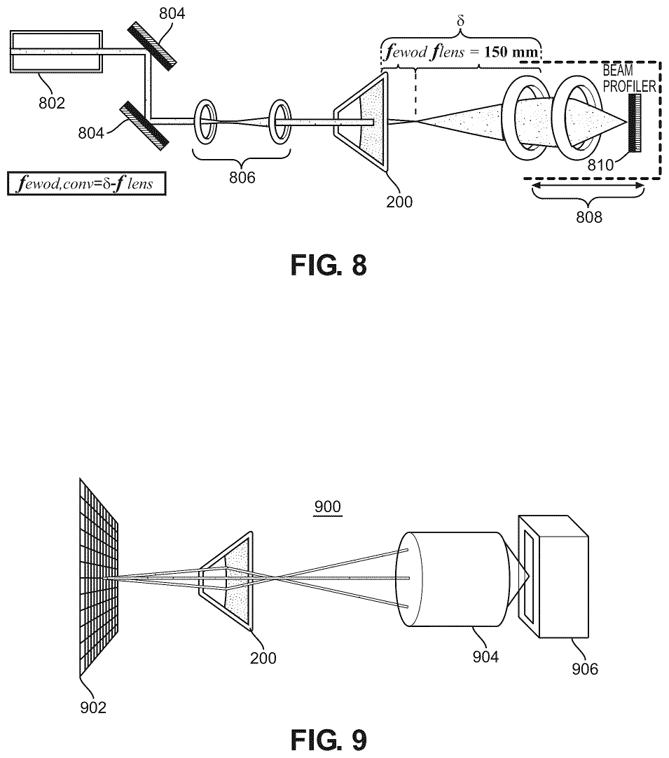

FIG. 8 is a side schematic block diagram of an imaging system illustrating focal length tunability. Collimated Laser Light Source 802 provides a 635 nm beam via mirrors 804 to optics 806 (here two lenses) to expand the beam into lens 200. The collimated beam was produced at a diameter of approximately 1 mm.

Optical system 806 comprises a translating imager 808 including a beam profiler 810. Focal length tunability was measured using translating imager 808. Spot size was minimized on profiler 810 so f_{ewod} and fₗₑₙₛ overlapped. Then the distance between lenses, δ, was used to compute back focal length.

Using this optical setup, the back focal length of the EWOD lens 200 was characterized by actuating the lens 200 and translating the imaging stage 808 along a rail to minimize the beam's spot size on beam profiler 810. After fixing the translational position along the rail, a microfine stage was used to minimize spot size more accurately. Since spot size minimization on the beam profiler indicated overlapping focal spots, the back focal length of the lens cavity could be determined by measuring the distance between elements.

FIG. 9 is a side schematic block diagram of a widefield imaging setup 900 used to qualitatively evaluate lens quality. Imaging plane 902 is imaged by lens 200 and camera lens 904 for detection at a CMOS detector 906. Camera focused through EWOD lens to magnify image at various potentials/CAs. To capture images through the liquid lens, a variable focus lens and camera were aligned along the optical axis of the tunable lens and manually focused. Various targets were magnified by applying different potentials across the tunable lens and refocusing the camera.

FIGS. 10A-10C are plots illustrating improved performance with overdriven voltage. Optimized overdriving produced 64% improvement in settling time.

To ensure the response measurement system was aligned correctly, an EWOD lens was actuated to a steady-state voltage, and the photodetector was positioned to maximize the measured signal through a 150 μm pinhole. Measurements were then recorded for a step response. An improved lens response was observed using overdrive input shaping. To find this optimal input shape, lens potential was overdriven by 50% and measured for overdrive potential times between 10 and 100 ms. Quantitatively, the step response of the lens had a 2% settling time of 414 ms, whereas an overdrive of 50% for 20 ms had a 2% settling time of 149 ms.

FIG. 10A shows simulated and measured device response intensity measurements to a step RMS input. FIG. 10B shows sweep of 50% overdrive input shapes to optimize the response time of the device. In addition to measuring the response of a lens from unactuated to actuated, a response was collected during lens relaxation. The result of this measurement yields a much quicker settling time of 11 ms. FIG. 10C shows a comparison of the overdrive-shaped lens response and step input response. Note the dramatic improvement in response time produced by the overdriving technique. The undulation in the overdriven rise is hypothesized to result from surface waves on the meniscus.

Meniscus response time is another common metric for assessing the maximum possible image-switching frequency of an EWOD lens. This is typically measured by focusing a collimated source through the lens and onto a photodetector. As the tunable lens was driven from an unactuated to a slightly convergent state, the intensity of the focused source was measured on a photodetector. A pinhole was located between the optic and photodetector to improve measurement fidelity, and the measurement was quantified using the 2% settling time of detector intensity. To characterize this embodiment, a 635 nm laser diode source was collimated to 0.5 mm FWHM, and the photodetector was apertured behind a 150 μm pinhole. For an RMS step input of 51 V at 3 kHz, our devices exhibited a response time of 414 ms in FIG. 10A. This response time agreed with the COMSOL model for the given driving voltage.

A COMSOL Multiphysics 6.1 model was used to predict meniscus response performance. First, the Laminar Flow package simulated meniscus curvature as a function of time in response to a potential step input. Next, Geometric Ray Tracing was applied to the time-dependent fluid solution to measure the focusing power of the meniscus onto a simulated photodetector. A relative intensity measurement was then obtained by normalizing the number of simulated rays contacting the detector at a given time step. For a simulation with a slip length of 8 nm, initial contact angle of 173°, and sudden DC input step voltage of 51 V, a 445 ms settling time was predicted (FIG. 10A). The difference in response concavity between the modeled and measured step responses is hypothesized to result from the asymmetric stick-slip movement of the liquid meniscus inside the polished cavity. This asymmetric behavior would push the focal spot of the lens off-axis until settling into its final position, producing the delayed rise in measured detector intensity.

We explored the use of a 50% potential overdrive to reduce meniscus action time. To optimize the response time of the lensing interface for this input shape, a sweep of overdrive times between 0 and 100 ms was performed. The results are plotted in FIG. 10B. Notably, using an overdrive input shape produced several responses with lower settling times than a step RMS input.

The greatest settling time improvement occurred for a 50% overdrive lasting 20 ms, resulting in a settling time of only 149 ms. This response time in FIG. 10C is on par with other devices of similar sizes. Overdriving is likely important to achieve a similar response time due to the longer contact point travel required by the conical geometry and the inability to remove all of the stick-slip-inducing valley defects in the metallic wetting surface. It is likely that an overdriven input enables the triple-phase contact line to more easily overcome unpolished trough points that can produce stick-slip behavior. Therefore, we recommend consideration of overdrive-based input shaping for trial in other EWOD optical systems.

While the exemplary preferred embodiments of the present invention are described herein with particularity, those skilled in the art will appreciate various changes, additions, and applications other than those specifically mentioned, which are within the spirit of this invention. For example, the metal cavity might be cooled or warmed to achieve different results. The material may be chosen for thermal stability. Other metals may be used, such as other aluminum alloys, stainless steel, titanium, or copper, depending on the conductivity desired and other material properties.

What is claimed is:

1. An electrowetting lens cavity comprising:
a metal chamber sized for use within an electrowetting lens;
wherein an inner surface of the metal chamber includes a portion that tapers downward to form an aperture; and
wherein the inner surface is smooth enough to allow electrowetting lensing within the electrowetting lens.

2. The electrowetting lens cavity of claim 1 wherein the inner surface forms a truncated cone.

3. The electrowetting lens cavity of claim 1 wherein the inner surface slope is between 30° and 60°.

4. The electrowetting lens cavity of claim 1 wherein the chamber is formed of aluminum.

5. The electrowetting lens cavity of claim 1 wherein a diameter of the aperture is smaller than a length of the portion of the inner surface that tapers downward.

6. The electrowetting lens cavity of claim 1 wherein the inner surface has roughness of under 0.1 μm.

7. The electrowetting lens cavity of claim 1 wherein the inner surface further comprises a dielectric layer and a hydrophobic layer.

8. An electrowetting lens comprising:
a housing;
an electrowetting lens cavity disposed within an upper portion of the housing, the electrowetting lens cavity comprising a metal chamber with an inner surface tapering downward to form an aperture;
wherein the inner surface of the electrowetting lens cavity is smooth enough to allow electrowetting lensing within the electrowetting lens;
an electrode and an electrode ground disposed for providing potential between a wall of the electrowetting lens cavity and above the electrowetting lens cavity;
a top window; and
a bottom window.

9. The electrowetting lens of claim 8 wherein in the top window includes an extension allowing electrical connection to circuitry for providing the potential.

10. The electrowetting lens of claim 9 wherein the top window forms the electrode ground.

11. The electrowetting lens of claim 8 further comprising circuitry between the electrode and the electrode ground for focusing the electrowetting lens by providing AC potential.

12. The electrowetting lens of claim 11 wherein the circuitry is configured to overdrive the electrowetting lens.

13. The electrowetting lens of claim 8 configured without adhesive.

14. The electrowetting lens of claim 8 wherein the electrode includes a screw sunk into the electrowetting lens cavity.

15. The electrowetting lens of claim 8 sized and shaped to fit a standard one-inch optical mount.

16. The method of forming an electrowetting lens comprising the steps of:
providing a housing;
providing an electrowetting lens cavity sized and shaped to fit within the housing;
providing top and bottom windows; and
providing means to apply a voltage between the electrowetting lens cavity and the top of the housing;
wherein the electrowetting lens cavity is formed of a metal chamber with an inner surface tapering downward to form an aperture and the inner surface of the electrowetting lens cavity is smooth enough to allow electrowetting lensing within the electrowetting lens.

17. The electrowetting lens cavity of claim 16 wherein the inner surface of the electrowetting lens cavity is formed of a metal chamber with an inner surface tapering downward to form an truncated cone.

18. The electrowetting lens cavity of claim 16 wherein a diameter of the aperture is smaller than a length of the inner surface that tapers downward.

19. The electrowetting lens cavity of claim 16 wherein the inner surface has roughness of under 0.1 μm.

20. The electrowetting lens cavity of claim 16 wherein the inner surface further comprises a dielectric layer and a hydrophobic layer.
